(19) United States
(12) Patent Application Publication
(10) Pub. No.: US 2007/0177774 A1
(43) Pub. Date: Aug. 2, 2007

(54) Fingerprint Recognition System Having Detecting Pore and Method Thereof

(75) Inventor: Peng-Chia Kuo, Taipei (TW)

Correspondence Address: LAW OFFICES OF LAI AND ASSOCIATES, P.C., 5800 RANCHESTER STE 200, HOUSTON, TX, 77036, US

(73) Assignee: Nanogate Optoelectronics Robot, Inc., Taipei (TW)

(21) Appl. No.: 11/307,282

(22) Filed: Jan. 30, 2006

(51) Int. Cl. G06K 9/00

(52) U.S. Cl. 382/124

(57) ABSTRACT

A fingerprint recognition system having detecting pore and a method are disclosed. The system comprises a fingerprint image capture apparatus, a pore detection apparatus, a fingerprint detection apparatus and a recognition apparatus. A fingerprint image is captured by the fingerprint image capture apparatus. A pore data of the fingerprint image is detected by the pore detection apparatus. A fingerprint data of the fingerprint image is detected by the fingerprint detection apparatus. The recognition apparatus is used to implement a comparison action for the fingerprint image and a pre-stored fingerprint image based on any one selection or combination from the pore data and the fingerprint data. The fingerprint recognition accuracy can be improved.

### FIELD OF THE INVENTION

The present invention relates to a fingerprint recognition system having detecting a pore and a method and, more particularly, to integrate a pore detection with a fingerprint detection into the fingerprint recognition system having detecting the pore and the method.

### BACKGROUND OF THE INVENTION

Currently, the fingerprint recognition device is in widespread use in electronic products for protecting the data within the electronic products. The principle of the conventional fingerprint recognition device is that the captured fingerprint image is compared with the pre-stored fingerprint image in the memory. However, the pure fingerprint image recognition process is deceived and cheated by fake fingerprints. For example, a faker may photocopy a plastic fingerprint from a stolen fingerprint image. FIG. 1A and FIG. 1B show two fingerprint images. The one is a fake fingerprint image and another one is true vital fingerprint. The conventional fingerprint recognition device can not recognize the fingerprint as true or false (Accurately, FIG. 1A shows a true vital fingerprint and FIG. 1B shows a fake fingerprint)

To recognize the fake fingerprint, a temperature detection technique is described in a conventional manner for applying the conventional fingerprint recognition device that not only increases system complexity, but also increases the volume of the fingerprint recognition device. Moreover, the faker may add temperatures on the fake fingerprint to cheat the fingerprint recognition device. In addition, a high-level fingerprint recognition device described in a conventional manner can detect blood capillaries within the fingers in order to distinguish the fake fingerprint. Although the high-level fingerprint recognition device can recognize the fingerprint as true or false, the system complexity, the high cost and the large volume for the high-level fingerprint recognition device diverge from the current fingerprint recognition device with the tendency of small volume and thin thickness. The blood capillary fingerprint recognition device can not be applied for general electronic products except specific applications or circumstances.

In addition, the injury may scar a user's finger if his finger is injured and the conventional fingerprint recognition device may make wrong recognitions. The user may not activate the electronic apparatus protected by the fingerprint recognition device that causes inconvenience.

To overcome the foregoing shortcomings of the prior arts, the inventor of the present invention based on years of experience on related research and development of the package for the image sensor to invent a fingerprint recognition system having detecting a pore and a method to overcome the foregoing shortcomings.

### SUMMARY OF THE INVENTION

Briefly, the object of the present invention is to provide integrating a pore detection with a fingerprint detection into a fingerprint recognition system having detecting a pore and a method in order to improve the fingerprint recognition accuracy, determine whether the fingerprint is true or false and have advantages for low cost and simple structure.

In accordance with the present invention the fingerprint recognition system having detecting the pore comprises a fingerprint image capture apparatus, a pore detection unit, a fingerprint detection unit and a recognition unit. A fingerprint image is captured by the fingerprint image capture apparatus, a pore data of the fingerprint image is detected by the pore detection unit, a fingerprint data of the fingerprint image is detected by the fingerprint detection unit and the recognition unit implements a comparison action for the fingerprint image and a pre-stored fingerprint image based on any one selection or combination from the pore data and the fingerprint data.

Furthermore, according to the present invention, a method of fingerprint recognition having a pore detection is further provided that comprises the steps: Capturing a fingerprint image; detecting a pore data of the fingerprint image; detecting a fingerprint data of the fingerprint image; implementing a comparison action for the fingerprint image and a pre-stored fingerprint image based on any on selection or combination from the fingerprint image and fingerprint data.

Other features and advantages of the present invention and variations thereof will become apparent from the following description, drawings, and claims.

### BRIEF DESCRIPTION OF THE DRAWINGS

FIG. 1A is a schematic diagram illustrating a true vital fingerprint image;

FIG. 1B is a schematic diagram illustrating a fake fingerprint image;

FIG. 2 is a block diagram illustrating a fingerprint recognition system having detecting a pore according to an embodiment of the present invention;

FIG. 3 is a block diagram illustrating the fingerprint recognition system having detecting a pore according to a preferred embodiment of the present invention;

FIG. 4 is a block diagram illustrating the pore detection unit according to a preferred embodiment of the present invention;

FIG. 5A is a schematic diagram illustrating a fingerprint image;

FIG. 5B is a schematic diagram illustrating the fingerprint image after processing by digital image processing technique;

FIG. 5C is a schematic diagram illustrating the fingerprint image after processing by digital image processing technique;

FIG. 5D is a schematic diagram illustrating two-dimensional mask parameter with 3×3;

FIG. 5E is a schematic diagram illustrating two-dimensional mask parameter with 4×4;

FIG. 6 is a block diagram illustrating the fingerprint recognition system having detecting a pore according to another preferred embodiment of the present invention;

FIG. 7 is a schematic diagram illustrating a spiral fingerprint pattern according to an embodiment of the present invention;

FIG. 8 is a flowchart illustrating a method for fingerprint recognition having a pore detection according to an embodiment of the present invention; and

FIG. 9 is a flowchart illustrating the method for fingerprint recognition having a pore detection according to a preferred embodiment of the present invention.

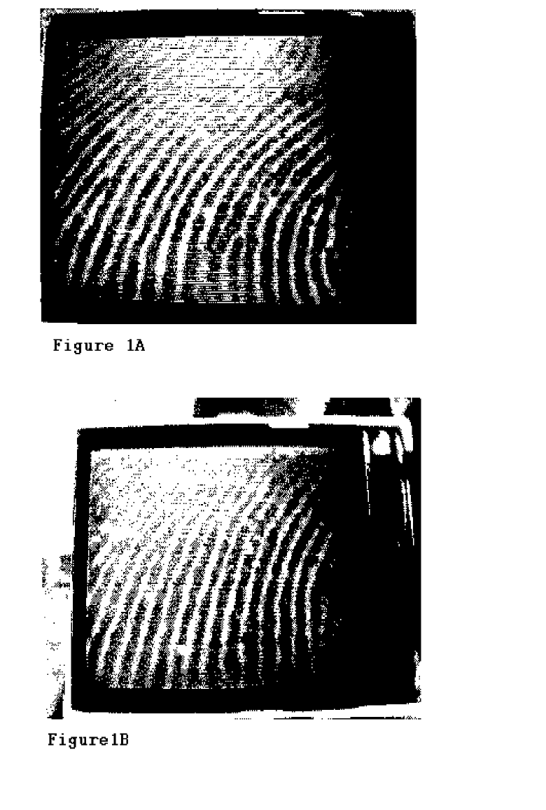

### DETAILED DESCRIPTION OF THE PREFERRED EMBODIMENTS

To make it easier for understanding the object of the invention, its innovative features and performance, a detailed description and technical characteristics of a fingerprint recognition system having detecting a pore and a method are described together with the drawings as follows.

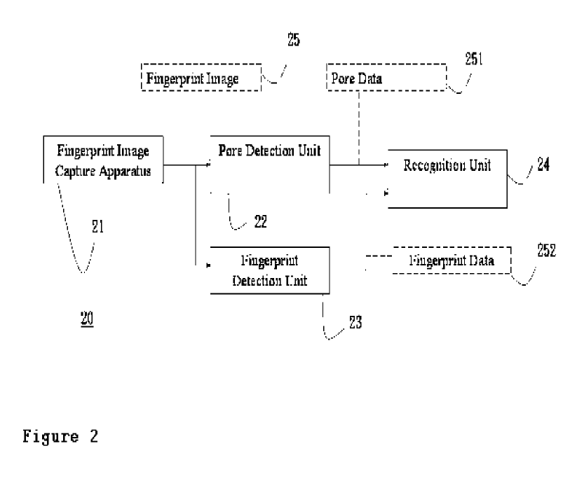

Referring to FIG. 2, a block diagram illustrates a fingerprint recognition system having detecting a pore according to an embodiment of the present invention. The fingerprint recognition system 20 comprises a fingerprint image capture apparatus 21, a pore detection unit 22, a fingerprint detection unit 23 and a recognition unit 24. A fingerprint image 25 is captured by the fingerprint image capture apparatus 21, a pore data 251 of the fingerprint image 25 is detected by the pore detection unit 22, a fingerprint data 252 of the fingerprint image 25 is detected by the fingerprint detection unit 23 and the recognition unit 24 implements a comparison action for the fingerprint image 25 and a pre-stored fingerprint image based on any one selection or combination from the pore data 251 and the fingerprint data 252.

In addition, the recognition unit 24 can determine whether the fingerprint image 25 is true or false based on the pore data 251. The fingerprint image 25 and a pre-stored fingerprint image are compared by the recognition unit 24 based on the pore data 251 or the fingerprint data 252 or based on the pore data 251 and the fingerprint data 252. The pore data 251 comprises a pore position 2511 or a pore shape 2512.

The fingerprint image capture apparatus 21 is a combination of a light source, an optical element and an image sensing device, or a digital camera. The light source can be a light emitting diode (LED), the optical element can be a prism and the image sensing device is a charge coupled device (CCD) or a complementary metal oxide semiconductor (CMOS) component. The pore detection unit 22, the fingerprint detection unit 23 and the recognition unit 24 can be achieved by using software, hardware or software and hardware combinations. To give an example of software, the pore detection unit 22 is that a pore detection program is executed by a microprocessor to accomplish or using an image processing chip, the fingerprint detection unit 23 is that a fingerprint detection program is executed by the microprocessor to accomplish or using the image processing program and the recognition unit 24 is that a recognition program is executed by the microprocessor to accomplish or using the image processing program. The pore detection program, the fingerprint detection program and the recognition program can be parallelly processed by a multiple procedure of the microprocessor or can be sequentially executed based on a fixed-sequence.

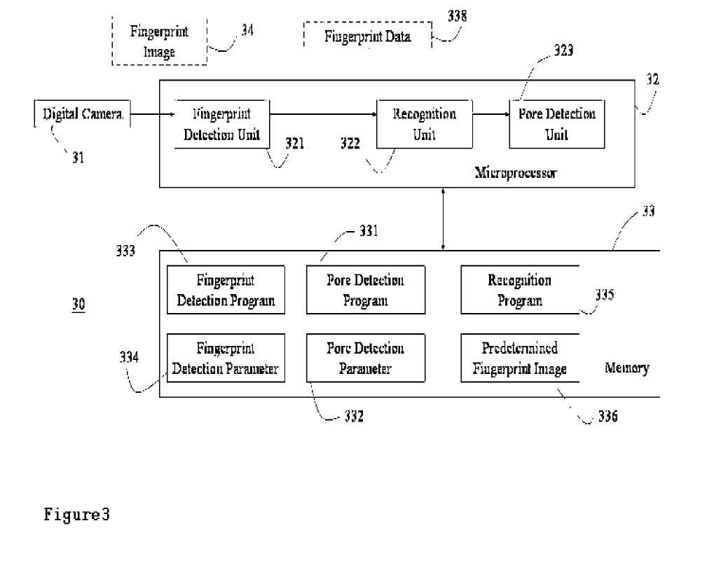

Referring to FIG. 3, a block diagram illustrates the fingerprint recognition system having detecting a pore according to a preferred embodiment of the present invention. The fingerprint recognition system 30 comprises a digital camera 31, a microprocessor 32, a memory 33, a fingerprint detection unit 321, a recognition unit 322 and a pore detection unit 323. The fingerprint detection unit 321, the recognition unit 322 and the pore unit 323 can be accomplished by software. A pore detection program 331, a pore detection parameter 332, a fingerprint detection program 333, a fingerprint detection parameter 334, a recognition program 335 and a predetermined fingerprint image 336 are stored in the memory 33. A fingerprint image 34 is captured by the digital camera 31 and is then transmitted to the microprocessor 32. The fingerprint detection program 333 and the fingerprint detection parameter 334 are fetched by the microprocessor 32 from the memory 33 and the fingerprint detection program 333 is executed to calculate a fingerprint data 338 of the fingerprint image 34. Next, the predetermined fingerprint image 336 and the recognition program 335 are fetched by the microprocessor 32 from the memory 33 and the recognition program 334 is executed to implement a comparison action for the fingerprint image 34 and the predetermined fingerprint image 336 based on the fingerprint data 338. Afterward, the pore detection program 331 and the pore detection parameter 334 are fetched by the microprocessor 32 from the memory 33 and the pore detection program 331 is executed to calculate a pore data of the fingerprint image 34 based on the pore detection parameter 334. The fingerprint image 34 can be determined as true or false by way of the pore data.

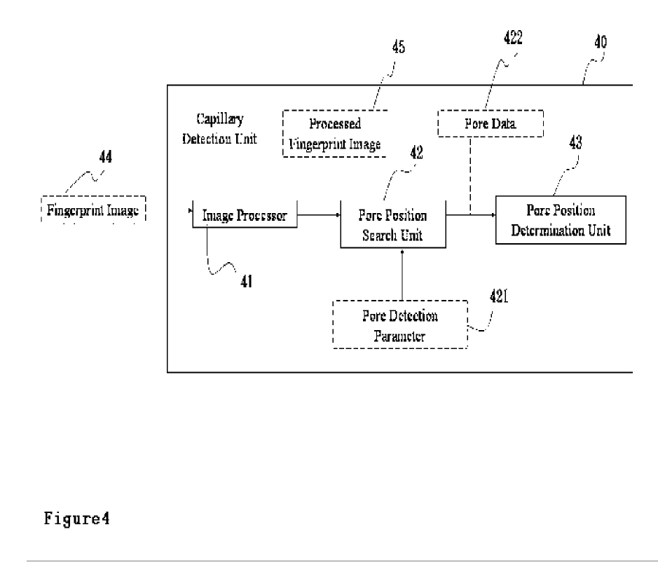

Referring to FIG. 4, a block diagram illustrates the pore detection unit as shown in FIG. 3 according to a preferred embodiment of the present invention. The pore detection unit 40 comprises an image processor 41, a pore position search unit 42 and a pore position determination unit 43. A fingerprint image 44 is received by the image processor 41 and a digital image processing is implemented for the fingerprint image 44 to generate a processed fingerprint image 45. The pore characteristic of the processed fingerprint image 45 is sharper than the pore characteristic of the fingerprint image 44. A pore data 422 of the processed fingerprint image 45 is found out by the pore position search unit 42 based on a pore detection parameter 421. The pore data 422 comprises the pore position, the pore shape or the pore area. The fingerprint image 44 can be determined by the pore position determination unit 43 as a real vital fingerprint image or a fake fingerprint image.

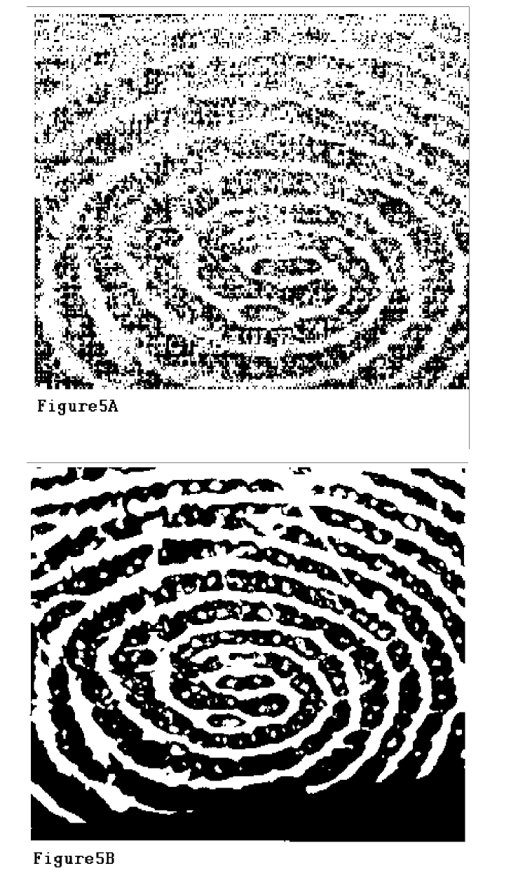

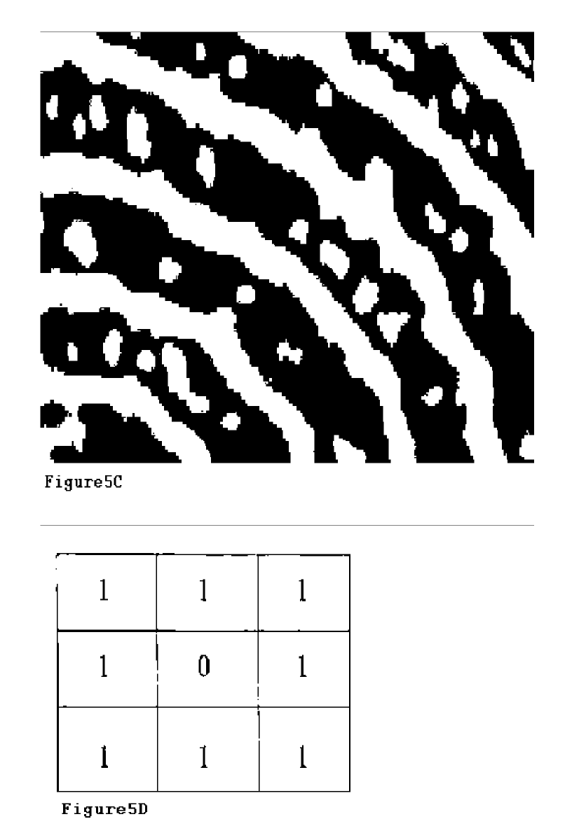

The digital image processing is to enhance the fingerprint image by increasing the contrast enhancement or the thresholding. A threshold must be decided first, a pixel value which is greater than the threshold is then set to be a higher value and a pixel value which is smaller than the threshold is set to be a lower value to generate the processed fingerprint image 45 while increasing the contrast enhancement as shown in FIG. 5A and FIG. 5B. FIG. 5A shows the fingerprint image 44 and FIG. 5B shows the processed fingerprint image 45. In FIG. 5B, black represents a peak portion of the fingerprint, white represent a trough portion and particle shapes in the black area are pores. Although the digital image processing technique of the contrast enhancement is used in the embodiment of the present invention, other digital processing techniques can also be used to bring recognizable between the pore image and the fingerprint image.

The pore detection parameter 421 is a two-dimensional mask parameter which can be 3×3 or 4×4, as shown in FIG. 5D and FIG. 5E. The processed image is compared and calculated by using two-dimensional mask parameter one by one, for instance, logical conjunction (AND). The pore shape or the pore position is obtained initially when one area of the fingerprint image with contrast enhancement coincides with the mask value, hence the pore of the processed fingerprint image 45 can be found out. In addition, the processed fingerprint image 45 can be processed by the pore position search unit 42 by using image dilation and image erosion to separate the pore image and the fingerprint image as shown in FIG. 5C. Next, connected pixels on the processed fingerprint image are calculated. The pore image is a pixel blob 51 and the fingerprint image is a spiral pixel blob or a linear pixel blob 52, both areas are different, hence the pore detection parameter 421 can be set to be a blob area threshold and the pixel blob which is less than the blob area threshold can be taken as the pore and therefore the pore of the processed fingerprint image 45 is found. Besides the pore position search unit 42 is used for above two embodiments, other digital image techniques can be applied to find out or detect the pore as well.

Lastly, the determination principle of the pore position determination unit 43 is described as follows. If the pore is in the fingerprint trough, in another word, white area of the processed fingerprint image 45 is shown in FIG. 5B, theses images from pores can not be captured by the fingerprint image capture apparatus. According to the phenomenon, if somebody would like to make some fake pores on a fake fingerprint, for instance, someone powdered some dust. In the image captured from the fake fingerprint, similar pore patterns are also acquired from the white area of the image. At this time, the fingerprint image 44 is then determined as a fake fingerprint image. On the other hand, if the pore is detected from the black area of the processed fingerprint image 45 and is not detected from the white area, the fingerprint image 44 is then determined as a true vital fingerprint image.

In addition, the image processor 41 as shown in FIG. 4 can be arranged in the fingerprint image capture apparatus 21 as shown in FIG. 2. In other words, the fingerprint image capture apparatus 21 has a digital image processing (It can be called front end processing that differs the image processor 41 as shown in FIG. 4) for obtaining a fingerprint image with higher contrast. The front end processing can be accomplished by hardware, such as digital camera with image processing or a prism with better optical performance, a lens or a sensor. Therefore, the higher processing speed can be achieved.

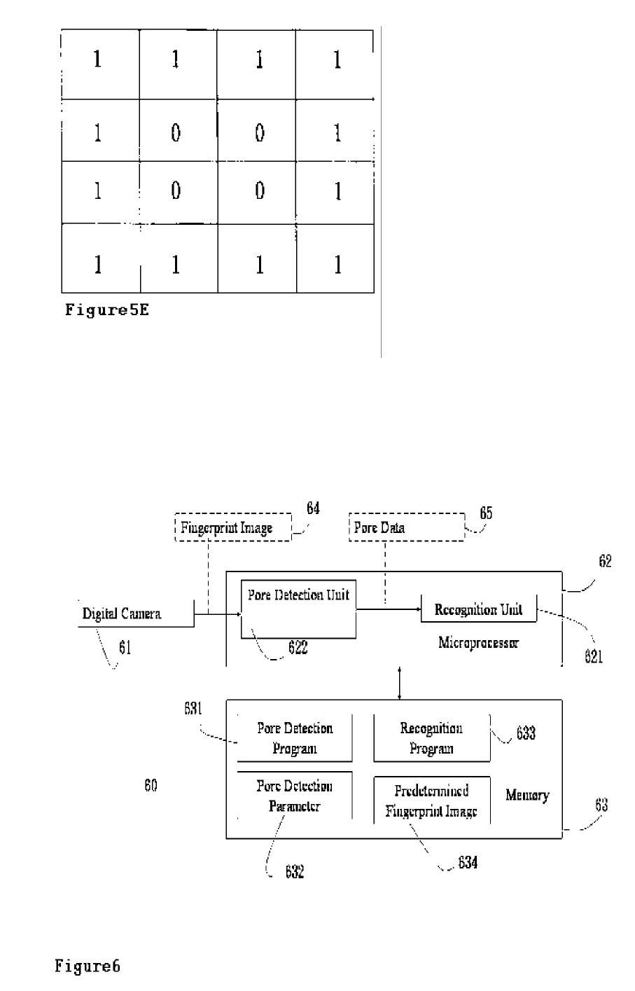

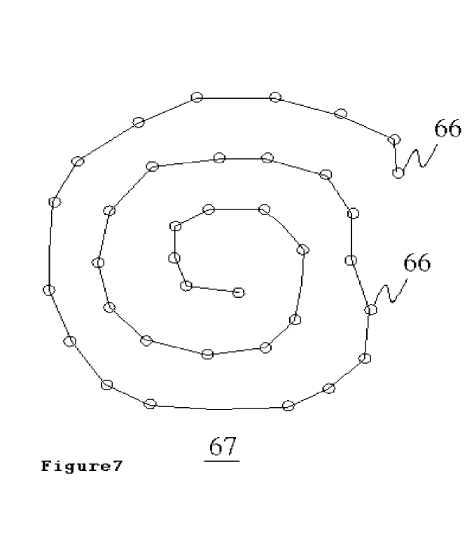

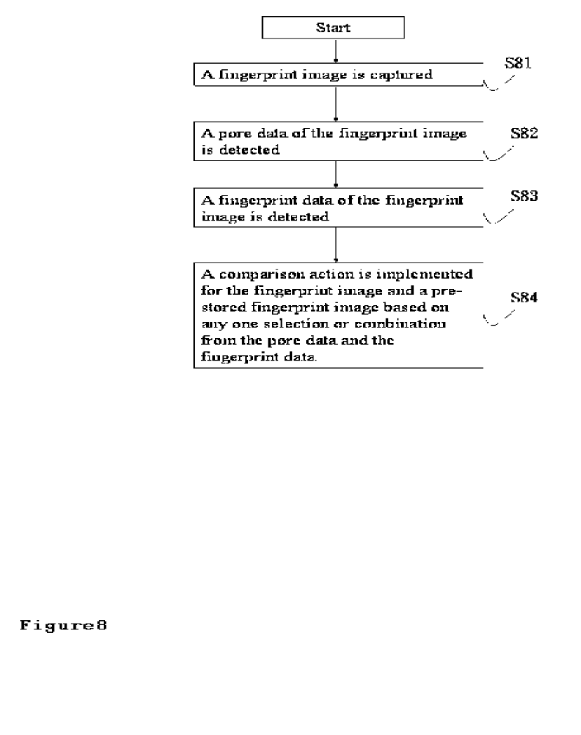

Referring to FIG. 6, a block diagram illustrates the fingerprint recognition system having detecting a pore according to another preferred embodiment of the present invention. The fingerprint recognition system 60 comprises a digital camera 61, a microprocessor 62, a memory 63, a recognition unit 621 and a pore detection unit 622. The recognition unit 621 and the pore detection unit 622 can be accomplished by software. A pore detection program 631, a pore detection parameter 632, a recognition program 633 and a predetermined fingerprint image 634 are stored in the memory 63. A fingerprint image 64 is captured by the digital camera 61 and is then transmitted to the microprocessor 62. The pore detection program 631 and the pore detection parameter 632 are fetched by the microprocessor 62 from the memory 63 and the pore detection program 631 is executed to calculate a pore data 65 of the fingerprint image 64 based on the pore detection parameter 632. The fingerprint image 64 is determined as true or false based on the pore data 65. If the fingerprint image 64 is a true fingerprint image, the recognition program 633 and the predetermined fingerprint image 64 are fetched by the microprocessor 62 from the memory 63 and the recognition program 633 is executed to implement a comparison action for the fingerprint image 64 and the predetermined fingerprint image 634 based on the pore data 65. The recognition program 633 is to implement a selectively connection for each pore 66 based on the pore data 65, so as to generate a spiral pattern 67 as shown in FIG. 7. Next, a comparison action is implemented for the fingerprint image 64 and the predetermined fingerprint image 634 based on the spiral pattern 67.

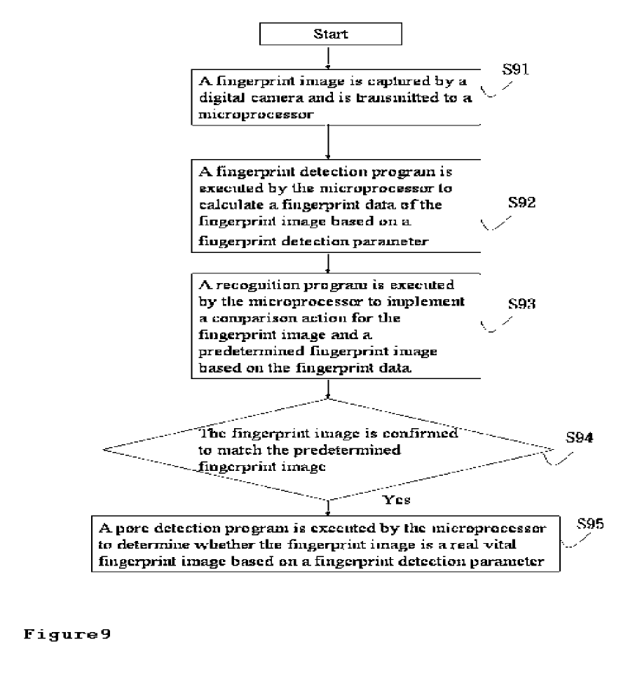

Referring to FIG. 8, a flowchart illustrates a method for fingerprint recognition having a pore detection according to an embodiment of the present invention. Step S81, a fingerprint image is captured. Next, step S82, a pore data of the fingerprint image is detected. Step S83, a fingerprint data of the fingerprint image is detected. Lastly, step S83, a comparison action is implemented for the fingerprint image and a pre-stored fingerprint image based on any one selection or combination from the pore data and the fingerprint data.

Referring to FIG. 9, a flowchart illustrates the method for fingerprint recognition having a pore detection according to a preferred embodiment of the present invention. Step S91, a fingerprint image is captured by a digital camera and is transmitted to a microprocessor. Next, Step S92, a fingerprint detection program is executed by the microprocessor to calculate a fingerprint data of the fingerprint image based on a fingerprint detection parameter. Step S93, a recognition program is executed by the microprocessor to implement a comparison action for the fingerprint image and a predetermined fingerprint image based on the fingerprint data. Step S94, the fingerprint image is confirmed to match the predetermined fingerprint image. Afterward step S95, if the fingerprint image matches the predetermined fingerprint image, a pore detection program is executed by the microprocessor to determine whether the fingerprint image is a real vital fingerprint image based on a fingerprint detection parameter.

Although the features and advantages of the embodiments according to the preferred invention are disclosed, it is not limited to the embodiments described above, but encompasses any and all modifications and changes within the spirit and scope of the following claims.

What is claimed is:

1. A fingerprint recognition system having detecting a pore, comprising:
a fingerprint image capture apparatus for capturing a fingerprint image;
a pore detection apparatus for detecting a pore data of said fingerprint image;
a fingerprint detection unit for detecting a fingerprint data of said fingerprint image; and
a recognition unit for implementing a comparison action for said fingerprint image and a pre-stored fingerprint image based on any one selection or combination from said pore data and said fingerprint data.

2. The fingerprint recognition system of claim 1, wherein said recognition unit is to determine whether said fingerprint image is true or false based on said pore data.

3. The fingerprint recognition system of claim 1, wherein said pore data comprises a pore position and a pore shape.

4. The fingerprint recognition system of claim 1, wherein said fingerprint image capture apparatus comprises a light source, an optical element and an image sensing device.

5. The fingerprint recognition system of claim 1, wherein said pore detection unit comprises an image processor, a pore position search unit and a pore position determination unit.

6. The fingerprint recognition system of claim 5, wherein said image processor is used to enhance a pore pattern within said fingerprint image to generate a processed fingerprint image.

7. The fingerprint recognition system of claim 5, wherein said pore position search unit is to search said processed fingerprint image based on one pore detection parameter, so as to generate said pore data, said pore data comprises a pore position.

8. The fingerprint recognition system of claim 7, wherein said pore position determination unit is used to determine whether said pore position is accuracy.

9. A method of fingerprint recognition having a pore detection, comprising:
capturing a fingerprint image;
detecting a pore data of said fingerprint image;
detecting a fingerprint data of said fingerprint image; and
implementing a comparison action for said fingerprint image and a pre-stored fingerprint image based on any one selection or combination from said pore data and said fingerprint data.

10. The method of fingerprint recognition having a pore detection of claim 9, wherein further comprises determining whether said fingerprint image is true or false based on said pore data.

11. The method of fingerprint recognition having a pore detection of claim 9, wherein said pore data comprises a pore position and a pore shape.
